(19) United States
(12) Patent Application Publication
(10) Pub. No.: US 2009/0150494 A1
(43) Pub. Date: Jun. 11, 2009

(54) JUST-IN TIME MAILING LIST TRAFFIC INDICATOR

(75) Inventors: Elaine I. Kuo, Chelmsford, MA (US); Fang Lu, Billerica, MA (US); Corey McCaffrey, Boston, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,849

(22) Filed: Dec. 5, 2007

(51) Int. Cl. G06F 15/16

(52) U.S. Cl. 709/206

(57) ABSTRACT

Traffic of email messages sent to an email list is monitored, and a number of email messages sent to the email list per day is determined. An average number of email messages sent to the email list per day is determined over a number of days. The determined average number of email message sent to the email list per day is updated every day. In response to a user request to send an email message to the email list on a given day, the user is presented with a traffic indicator. The traffic indicator includes an updated average number of email messages sent to the email list per day and a number representing how many email messages have been sent to the email list on the given day at the time the user requests to send the email message.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

This invention relates to electronic messaging, and, in particular, to indicating traffic for an electronic messaging mailing list.

When a user subscribes (or is subscribed, e.g., by his or her employer for work-related purposes) to an electronic mailing list, the user invites a certain amount of e-mail traffic into his or her inbox. Depending on the nature of the list, if too few messages associated with the list are received, the user may forget about the list or lose interest in it. If too many messages associated with the list are received, the user may become frustrated by the flood of information and remove himself or herself from the list.

For group discussion e-mail lists that are not moderated, the responsibility to maintain reasonable levels of traffic falls upon the individual users of the group. When sending a message to a group, a user must consider whether the message merits the attention of the group. Even if the message is relevant, the user must also consider whether sending the message will cause the group's daily or weekly tolerance for new messages to be exceeded.

Today, some users make these judgment calls based on their memory of historical group usage, while other users disregard the importance of considering the patience and usage patterns of the rest of the group. With the ever-increasing use of e-mail and mailing lists in the workplace and elsewhere, it is becoming increasingly difficult for users to make these judgment calls and tolerate other users who do not consider the effects of sending emails to the group.

### SUMMARY

According to an exemplary embodiment, a method for presenting a just-in-time email list traffic indicator to a user that is a member of the email list is provided. Traffic of email messages sent to the email list is monitored, and a number of email messages sent to the email list per day is determined. An average number of email messages sent to the email list per day is determined over a number of days. The determined average number of email messages sent to the email list per day is updated every day. In response to a user request to send an email message to the email list on a given day, the user is presented with a traffic indicator in a header of the email message. The traffic indicator includes an updated average number of email messages sent to the email list per day and a number representing how many email messages have been sent to the email list on the given day at the time the user requests to send the email message. The number representing how many email messages have been sent to the email list takes into account the email message the user requests to send to the email list.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C illustrate headers presented to users via a just-in-time mail list traffic indicator tool according to exemplary embodiments.

FIG. 2 illustrates a method for presenting a just-in-time mailing list traffic indicator according to exemplary embodiments.

The detailed description explains exemplary embodiments, together with advantages and features, by way of example with reference to the drawings.

### DETAILED DESCRIPTION

According to exemplary embodiments, a Just-in-Time Mailing List Traffic Indicator (JMLTI) provides users with periodic averages, e.g., daily or weekly averages, of the number of email messages processed through an electronic mailing list at the time the user adds the address of the mailing list to the header fields of an e-mail message. This indicator serves as a reminder to users that they should consider normal traffic patterns of a mailing list when deciding whether it is an appropriate time to send a message, as well as eliminate the guesswork required to make that decision.

The JMLTI is a user interface element that provides additional information in an e-mail client about mailing lists that support the JMLTI feature. For example, Lotus Domino servers that manage mailing lists can track a moving average of the daily traffic and the current day's use for those mailing lists and expose the data through an Application Program Interface (API) to programs, such as Lotus Notes, which then can show that data in the form of the JMLTI.

As an example, suppose there is a mailing list called “Flannel Enthusiasts,” that anyone can join to discuss their favorite patterns and enjoyment of wearing flannel fabric. Suppose that over the past 15 days, the group has seen the following traffic:

### Day (# Messages)

1(4), 2(5), 3(0), 4(2), 5(0), 6(7), 7(4), 8(3), 9(1), 10(1), 11(2), 12(0), 13(5), 14(1), 15(2)

Suppose also that the email server used by group is configured to maintain a 10-day simple moving average for the group, so the daily average traffic today is (2+1+5+0+2+1+1+3+4+7)/10=3 messages per day, rounded to the nearest message. Furthermore, suppose that in a given day, two messages have already been sent to the group. In one message, a user “Fred” sent a link to a sale on flannel pajamas to users on the list, and in another message, a user “Jane” sent a photograph of her new flannel sheets to users on the list. Now suppose that a user wants to reply to Fred's message on the same day to let everyone in the group know that the pajamas are now sold out. The user starts up the JMLTI-enabled e-mail client application, finds Fred's message, and presses reply to all.

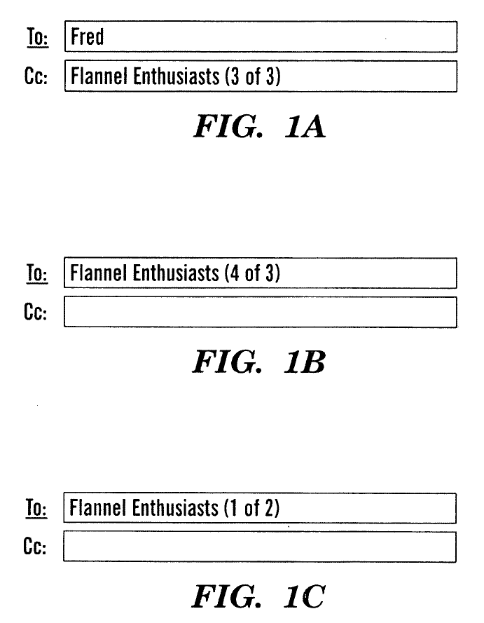

Upon pressing reply to all, the header shown in FIG. 1A is presented to the user. The header includes “Fred” in the “To” field and the email list “Flannel Enthusiasts” in the “Cc” field. Also, in the “Cc” field, a traffic indicator is presented including the average number of messages sent to the group each day (in this case, 3) and the number of messages sent that day taking into account the message the user currently wants to send (in this case 3). As indicated by the header shown in FIG. 1A, if the user sends a reply to Fred's message to the group, that reply will be the third message sent that day to a mailing list that generally gets about three messages a day. Instead of the displaying the information in the “Cc” filed in normal black text, the mailing list name and numbers may appear, e.g., in a dark shade of red in the “Cc” field to indicate that the message would be within the normal limits but close to exceeding them. Suppose that the user decides that the reply to Fred's message would be highly relevant to the group and within their normal traffic expectation, so the user decides to go ahead and send the message.

Later that day, suppose the same user wants to send a message to the group describing a cool dream he or she had the night before in which everyone was wearing black-and-blue flannel. The user creates a new message with “Flannel Enthusiasts” in the “To” field.

When the user presses Return, the JMLTI-enabled e-mail client checks the directory server to verify the address and download the JMLTI data. Then, the user is presented with a header as shown in FIG. 1B. As shown in FIG. 1B, the “To” field includes “Flannel Enthusiasts”, along with an indicator indicating the number of messages typically received by the mailing list per day and the number of messages sent so far that day, taking into account the message the user currently wants to send. In this case, the mailing list may be colored, e.g., bright red to indicate that if the user sends this message, it will exceed the number of message typically received by the email list. A quick check of the indicator reveals that the message will be the fourth message that day on a list that gets an average of three messages a day. Now it is up to the user whether to compose and send the message. Suppose that, knowledgeable at a glance of the current and expected traffic to this group, the user decides that the message is not urgent and can wait until tomorrow. So, the user saves the message as a draft.

The next morning, suppose the user opens the draft of the message created the night before. FIG. 1C illustrates a header that is presented to the user.

The JMLTI automatically queried the directory server and updated with today's data. The moving average updated itself, kicking out day 6 and including day 16 (yesterday):

(3+2+1+5+0+2+1+1+3+4)/10=2

Since the message is the first of the day, and the moving average is now 2, the JMLTI reads “(1 of 2)” and the indicator may be colored black to indicate that the message is well within the day's expected quota.

The example given above demonstrates the usefulness of providing a traffic indicator to a user desiring to send an email message to a mailing list. The JMLTI provides users with timely and relevant information about the traffic of a mailing list in an unobtrusive way. Use of the JMLTI will alleviate the pain of making the decision about whether to post a message to a particular mailing list as well as the pain of having to deal with those who do not take the time make an informed decision.

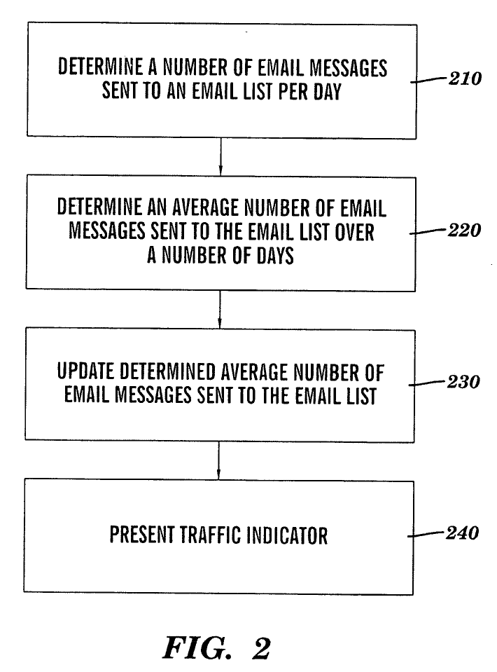

FIG. 2 illustrates a method for presenting a just-in-time mailing list traffic indicator according to exemplary embodiments. Traffic of email messages sent to the email list is monitored, and a number of email messages sent to the email list per day is determined at step 210. An average number of email messages sent to the email list per day over a number of days at step 220. The average may be determined on a daily basis, weekly basis, or some over some other periods of a number of days. The determined average number of email messages sent to the email list per day is updated every day at step 230. Alternatively, the average may be updated every number of days, e.g., weekly. At step 240, a user is presented with a traffic indicator in response to a user request to send an email message to the email list on a given day. The traffic indicator includes an updated average number of email messages sent to the email list per day and a number representing how many email messages have been sent to the email list on the given day at the time the user requests to send the email message. The number representing how many email messages have been sent to the email list takes into account the email message the user requests to send to the email list.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

What is claimed is:

1. A method for presenting a just-in-time email list traffic indicator to a user that is a member of the email list, comprising:
monitoring traffic of email messages sent to the email list and determining a number of email messages sent to the email list per day over a number of days;
determining an average number of email messages sent to the email list per day over the number of days;
updating the determined average number of email message sent to the email list per day every day; and
presenting, in response to a user request to send an email message to the email list on a given day, a traffic indicator in a header of the email message, wherein the traffic indicator includes an updated average number of email messages sent to the email list per day and a number representing how many email messages have been sent to the email list on the given day at the time the user requests to send the email message.

2. The method of claim 1, wherein the number representing how many email messages have been sent to the email list takes into account the email message the user requests to send to the email list.

3. The method of claim 1, wherein the indicator is highlighted if the number representing how many messages have been to the email list on the given day is equal to or greater than the current average number of email messages sent to the email list per day.

4. The method of claim 3, wherein if the indicator is highlighted to a degree indicative of how much the number representing how many messages have been sent to the email list exceeds the current average number of email messages sent to the email list per day.
